(19) United States
(12) Patent Application Publication
(10) Pub. No.: US 2009/0197531 A1
(43) Pub. Date: Aug. 6, 2009

(54) Method and system for patching a communication line using magneto-inductive signals

(75) Inventors: Evan Locke, Porters Lake (CA); Don Dinn, Dartmouth (CA)

Correspondence Address: MINTZ, LEVIN, COHN, FERRIS, GLOVSKY AND POPEO, P.C, ONE FINANCIAL CENTER, BOSTON, MA, 02111, US

(73) Assignee: Magneto-Inductive Systems Limited

(21) Appl. No.: 12/012,818

(22) Filed: Feb. 5, 2008

(51) Int. Cl. H04B 7/00

(52) U.S. Cl. 455/41.2

(57) ABSTRACT

A system and method for patching a break in a communication line using magneto-inductive signals. The magneto-inductive signals are modulated data signals having a carrier frequency below 10 kHz. Multiple magneto-inductive communication units are placed in spaced relation on a communication line. A break in the communication line is detected between two of the units and the units establish a magneto-inductive link to relay communication signals from the communication line, thereby patching the break.

### FIELD OF THE INVENTION

The present invention relates to magneto-inductive systems, and, in particular, to methods and systems for patching a break in a wired communication line using magneto-inductive signals.

### BACKGROUND OF THE INVENTION

Traditional wireless electronic communications encounter particular difficulties in certain environments. For example, in underground or underwater environments, signal attenuation presents a particular problem for RF signals.

In mining applications, RF communication systems typically involve the use of a wired infrastructure within the mine. For example, so-called “leaky feeder” cables may be placed within mine tunnels to facilitate RF-level transmissions between mobile handheld units and other mobile handheld units or a basestation. Such cables are designed to enable radio transmissions to both leak from the cable and also enter the cable. The leaky feeder cables act like a long antenna or waveguide to permit wireless RF communication between two stations separated by intervening media, like earth and rock, that significantly attenuates direct wireless transmissions.

Unfortunately, the use of physical cables contains an inherent risk that the cables may be broken. This is of particular concern in a mining environment, where falling rocks may damage or sever a leaky feeder cable, rendering communication in emergency situations impossible.

Short range wireless communication systems have been developed for use within underground environments, using magneto-inductive technology. Magneto-inductive communications use quasi-static low frequency AC magnetic fields. A quasi-magnetic field differs from an electromagnetic field in that the electric field component is negligibly small. A quasi-static magnetic field does not propagate as an electromagnetic wave, but instead arises through induction. Accordingly, a quasi-static magnetic field is not subject to the same problems of reflection, refraction or scattering that radio frequency electromagnetic waves suffer from, and may thus communicate through various media (e.g. earth, air, water, ice, etc.) or medium boundaries.

Typical magneto-inductive (MI) systems include a magneto-inductive transmitter and a magneto-inductive receiver, and operate in the range of a few hundred Hz to 10 kHz. More typically, the operating frequency of an MI system is in the range of 500 to 3000 Hz.

MI systems find application in undersea operations, mining, military, and other such fields. They may be used, for example, to perform remote triggering of explosives for mining operations or munitions for military operations. By way of example, U.S. Pat. No. 6,253,679 to Woodall et al. describes a specific magneto-inductive remote triggering system for line charges used in amphibious assaults.

### SUMMARY OF THE INVENTION

The present application describes systems, units, and methods for patching a communication line using magneto-inductive signals. The magneto-inductive signals are modulated data signals having a carrier frequency below 10 kHz.

In one aspect, the present application describes a magneto-inductive patch unit for connection to a communication line which carries a communication signal. The communication line is connected to at least one other magneto-inductive patch unit. The magneto-inductive patch unit includes a controller, an antenna having at least one loop for creating a magnetic field, a transmit module and an interface circuit. The interface circuit is connected to the communication line and includes a modem for demodulating the communication signal received from the communication line to obtain a data signal, and a break detection module configured to determine whether the communication line between the magneto-inductive patch unit and the other magneto-inductive patch unit is broken. The transmit module is connected to the antenna for modulating the data signal at a carrier frequency to generate and output a modulated data signal to drive the antenna, the carrier frequency being below 10 kHz.

In another aspect, the present application provides a magneto-inductive patch system for patching a broken communication line which carries a communication signal. The system includes a first magneto-inductive unit connected to the communication line and a second magneto-inductive unit connected to the communication line. The first magneto-inductive unit includes a first controller, a transmit antenna having at least one loop for creating a magnetic field, a first interface circuit, and a transmit module. The interface circuit is connected to the communication line and includes a first modem for demodulating the communication signal received from the communication line to obtain a data signal, and a first break detection module. The transmit module is connected to the first antenna for modulating the data signal at a carrier frequency to generate and output a modulated data signal to drive the first antenna, the carrier frequency being below 10 kHz. The second magneto-inductive unit includes a second controller, a receive antenna having at least one loop for coupling to the magnetic field to receive the modulated data signal, and a receive module connected to the receive antenna for demodulating the modulated data signal to recover the data signal. It also includes a second interface circuit connected to the communication line, the interface circuit comprising a second modem for modulating the data signal to generate a reproduced communication signal and for transmitting the reproduced communication signal over the communication line, and a second break detection module. The first break detection module is configured to determine whether there is a break in the communication line between the first magneto-inductive unit and the second magneto-inductive unit.

In yet a further aspect, the present invention describes a method of patching a break in a communication line, which carries a communication signal, using a magneto-inductive system that includes a first magneto-inductive unit connected to the communication line and a second magneto-inductive unit connected to the communication line. The first magneto-inductive unit has a transmit antenna having at least one loop for creating a magnetic field, and the second magneto-inductive unit has a receive antenna for coupling to the magnetic field. The method includes the steps of detecting a break in the communication line between the first magneto-inductive unit and the second magneto-inductive unit, demodulating the communication signal to obtain a data signal within the first magneto-inductive unit, modulating the data signal at a carrier frequency to generate a modulated data signal to drive the transmit antenna, wherein the carrier frequency is below 10 kHz, receiving an induced signal in the receive antenna, demodulating the induced signal to recover the data signal, modulating the recovered data signal to produce a reproduced communication signal, and transmitting the reproduced communication signal on the communication line.

### BRIEF DESCRIPTION OF THE DRAWINGS

Reference will now be made, by way of example, to the accompanying drawings which show an embodiment of the present application, and in which:

FIG. 1 diagrammatically shows a leaky feeder communication system;

FIG. 2 diagrammatically shows an example embodiment of an MI patch system; and

FIG. 3 diagrammatically shows a further example embodiment of an MI patch system.

Similar reference numerals are used in different figures to denote similar components.

### DESCRIPTION OF SPECIFIC EMBODIMENTS

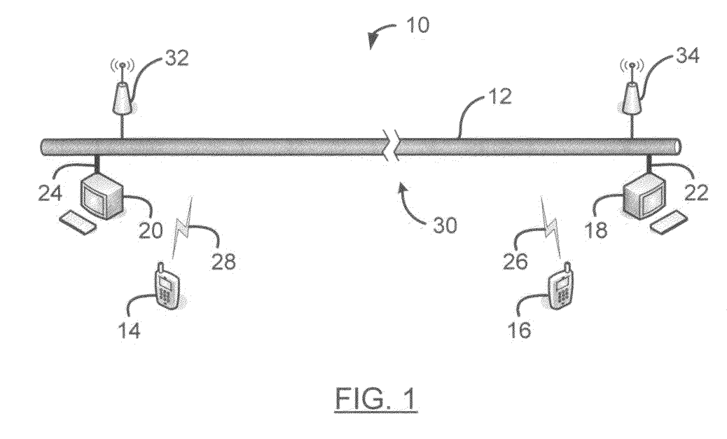

Reference is first made to FIG. 1, which shows a wired communication system 10, of the type used in mining environments. The communication system 10 includes a communication line 12. In a mining environment, the communication line 12 is typically a “leaky feeder” line. A leaky feeder line is designed to enable radio transmissions to both leak from the communication line 12 and also enter the communication line 12. The leaky feeder line acts much like a long antenna. To enable a signal to leak through into and out of the leaky feeder line, the leaky feeder line typically comprises a coaxial cable which has deliberately imperfect screening, such as slots in the outer shielding conductor, to allow wireless RF signals to enter the center conductor.

Leaky feeder systems typically allow for multiple channels of data. Each channel operates within a separate range of frequencies. To prevent overlap in interference, there is typically a gap between the various frequency bands. The use of multiple channels allows transmissions to be sent in a particular direction along the communication line 12. That is, upstream communications may operate at a different frequency range than downstream communications.

The communication line 12 carries data such as audio communications or other data. Typically, communication line 12 interfaces with mobile handheld units 14 and 16 which are in close proximity to the communication line 12 via RF communication. The communication line 12 may also physically connect to communication units 18 and 20. The communication system 10 may further include amplifiers and other components for ensuring that RF signals from, for example, the first mobile handheld unit 14 are received by, for example, a base station such as communication unit 18.

With a communication system 10 as shown in FIG. 1, if there is a break 30 in communication line 12 at a point between a first mobile handheld unit 14 and a second mobile handheld unit 16, the mobile handheld units 14 and 16 may not be able to communicate with each other.

To address the risk of a break in the communication line 12, the communication system 10 includes a number of magneto-inductive units connected to the communication line 12 at regularly spaced intervals. The magneto-inductive units are capable of detecting a break in the communication line 12 and establishing a magneto-inductive link between two adjacent units to bridge the break in order to maintain communications on the system 10.

Referring still to FIG. 1, the communication system 10 includes a first magneto-inductive unit 32 and a second magneto-inductive unit 34. The first magneto-inductive unit 32 and/or the second magneto-inductive unit 34 detect the break 30 in a section of communication line 12 between them. The magneto-inductive units 32, 34 then establish a magneto-inductive link over which they relay signals obtains from the communication line 12. In this manner, communications may be maintained over the communication system 10 despite the break 30.

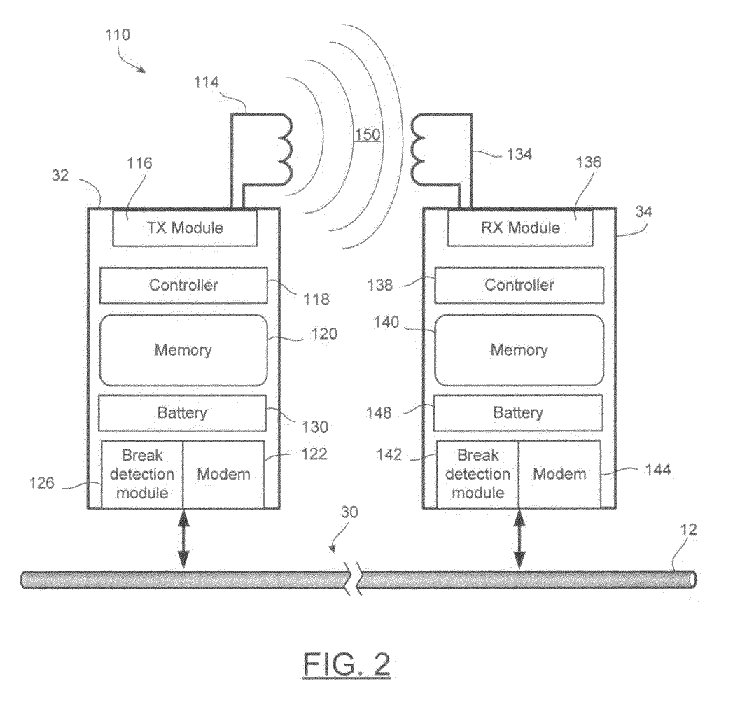

Reference will now be made to FIG. 2, which diagrammatically shows an example embodiment of an MI patch system 110. The MI patch system 110 includes the first MI unit 32 and the second MI unit 34. Both the first MI unit 32 and the second MI unit 34 are connected to the communication line 12.

The first MI unit 32 includes a transmit antenna 114. It will be appreciated by one skilled in the art that there are many different methods of constructing a transmit antenna 114. In one example embodiment, the transmit antenna 114 may include a single loop of wire. In other embodiments the transmit antenna may include multiple turns. In other embodiments, the transmit antenna 114 may include multiple strands and coils that are switchable between serial and parallel connections to change the characteristics of the antenna, such as is described in U.S. Pat. No. 6,333,723 to Locke, owned in common herewith. This configuration is the most useful if the first MI unit 32 is set up to act as a transceiver, i.e. capable of both transmitting and receiving functions. The contents of U.S. Pat. No. 6,333,723 are incorporated herein by reference.

In the example embodiment, the first MI unit 32 includes a modem 122 for demodulating a signal that is received from the communication line. The precise design and operation of the modem 122 is dependent on the specifications of the communication line 12. The suitable selection or design of the modem 122 for a given communication line 12 will be within the skill of an ordinary person in the art.

The first MI unit 32 also includes a transmitter module 116, a controller 118, and a break detection module 126. The transmitter module 116 generates a drive signal for powering the antenna 114 and performs modulation of a data signal supplied by the controller 118 with the drive signal. The drive signal, or carrier signal, in one example is a square wave at or below the resonant frequency of the transmit antenna 114 which is below 10 kHz. Other AC drive signals may be used in other embodiments, including sinusoids, etc.

The controller 118 may be implemented by way of a suitably programmed microcontroller or microprocessor. Software control of the controller 118 may be by way of operating programs stored in local memory, such as memory 120, or firmware within the first MI unit 32.

The first MI unit 32 may also include a memory 120. The controller 118 may access the memory 120 to retrieve or store data. For example, the controller may buffer data received from the modem 122, prior to transmission via the transmitter module 116. In another example, the controller 118 may read data stored in the memory and send the read data to the transmitter module for transmission. The memory 120 may be random access memory (RAM), flash memory, or read-only memory (ROM).

The transmitter module 116 may use, for example, FM modulation; although, other modulation techniques are possible. In one specific example, the transmitter module 116 uses a continuous-phase frequency shift keyed (FSK) modulation technique to modulate the carrier signal with the data signal. In some embodiments, the bandwidth of the FSK modulated signal may be between 2.5 Hz and 1200 Hz around the carrier or drive frequency. In one embodiment, the transmitter module 116 uses on-off keying. Other modulation techniques, such as amplitude modulation or phase shift keying, may be used in particular embodiments. In typical embodiments, the data rate may vary from 5 bits per second to 2400 bits per second dependent on the drive signal frequency and the requirements of the particular application. For example, applications that transmit audio signals require high data rate, such as 2400 bits/sec.

The transmitter module 116 modulates the drive or carrier signal with the data signal to generate a modulated data signal. The modulated data signal is used to drive the transmit antenna 114. The transmit antenna 114 generates a quasi-static magnetic field 150 based on the modulated data signal.

The second MI unit 34 includes a receive antenna 134. As with the transmit antenna 114, the receive antenna 134 may include a single loop, multiple turns of a coil antenna, or a switchable antenna. The receive antenna 134 is not necessarily physically identical to the transmit antenna 114, although it is tuned to the same approximate resonant frequency, i.e. the carrier or drive frequency.

The quasi-static magnetic field 150 generated by the transmit antenna 114 induces a received signal in the receive antenna 134. The received signal is input to a receiver module 136, which may perform filtering and amplification, and may demodulate the received signal to recover the data signal.

The second MI unit 34 also includes a controller 138. The controller 138 receives the demodulated data signal recovered from the received signal by the receiver module 36. In response to the data signal, the controller 138 may take various actions in accordance with its operating program and the contents of the data signal.

In one embodiment, the second MI unit 34 includes a memory 140. The memory 140 may be random access memory (RAM), flash memory, or read-only memory (ROM).

The second MI unit 34 also includes a modem 144. The modem 144 performs demodulation and modulation functions as necessary to prepare a received data signal for transmission over the communication line 12. The precise design and operation of the modem 144 depends in part on the specifications of the communication line 12.

Both the first MI unit 32 and the second MI unit 34 contain break detection modules 126 and 142 respectively. The break detection modules 126 and 142 identify or detect the break 30 in the communication line 12 at a point between the first MI unit 32 and the second MI unit 34.

In one embodiment, the first break detection module 126 of the first MI unit 32 transmits a check break data signal along the communication line 12. The first break detection module 126 then waits for a predetermined amount of time to receive a line status response from the second break detection module 142 of the second MI unit 34 to indicate that the check break data signal was received and the communication line 12 is properly transmitting data. If the first break detection module 126 does not receive a line status response from the second break detection module 142 within the predetermined time period, the first MI unit 32 determines that a break has occurred in the communication line 12 between it and the second MI unit 34. The first break detection module 126 may include a timer component for determining whether the line status response has been received within the pre-defined time period. If the timer component times out, i.e. no response signal is received, then the break detection module 142 alerts the controller 118 to the detection of a break in the communication line 12. It may, for example, output a break detected signal to the controller 118. The first MI unit 32 then seeks to establish the magneto-inductive link and begins to transmit data received from the communication line 12 via the magneto-inductive field 150.

In a communication system 10 (FIG. 1) employing a series of magneto-inductive units, the break detection modules of each magneto-inductive unit may transmit the check break data signal to their immediate neighbour on the communication line 12. A failure to receive a response from the neighbouring unit indicates a break between the sending unit and its neighbour. Each of the magneto-inductive units may have pre-assigned addresses or identifiers and the break detection modules may be configured to address their check break data signals to their respective neighbouring units using the identifier or address information. The precise nature of the check break data signals and the addressing of those signals partly depend upon the specifications of the communication line 12.

In another embodiment, the second break detection module 142 of the second MI unit 34 is configured to transmit, at a given interval, a keepalive signal onto the communication line 12. The first break detection module 126 in the first MI unit 32 monitors the time elapsed since the last receipt of a keepalive signal. Again, the first break detection module 12 may include a timer component for determining whether the keepalive signal has been received within a predetermined window of time. After the passage of the predetermined amount of time, if the first break detection module 126 has not received a keepalive signal it determines that there is a break in the communication line 12 between the MI units 32 and 34 and alerts the controller 118. The controller 118 causes the first MI unit 32 to begin to transmit data from the communication line 12 to the second MI unit 24 over the magnetic field 150. The second MI unit 34 may recognize the break 30 in the communication line 12 by detecting that the first MI unit 32 is seeking to establish the magneto-inductive link.

In another embodiment, both the first break detection module 126 and the second break detection module 142 may transmit a check break data signal onto the communication line 12. Each break detection module 126 and 142 will then await a line status response from the other break detection module 142 and 126. In this embodiment, both the first MI unit 32 and the second MI unit 34 will recognize a break in the line.

In yet another embodiment, the break detection modules 126, 142 may detect a break in the communication line 12 based on a loss of DC power in the communication line 12. It will be appreciated that all the MI units connected on the upstream side of the break will still receive power and all the MI units connected on the downstream side of the break will detect a loss of power. The units on the downstream side may use ping signals, via the communication line or via magneto-inductive signals, to determine which unit is adjacent the break.

Other mechanisms for detecting a break in the communication line will be appreciated by those ordinarily skilled in the art. It will also be appreciated that the roles of the first break detection module 126 and the second break detection module 142 may be reversed in some instances.

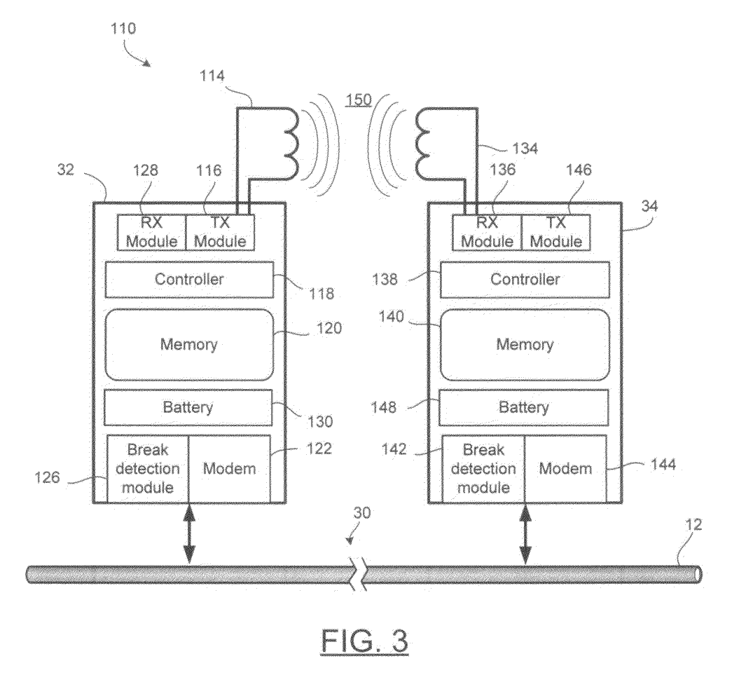

In another embodiment, as illustrated diagrammatically in FIG. 3, the first MI unit 32 contains a receiver module 128 and the second MI unit 34 contains a transmitter module 146. In this embodiment, the communication system 10 provides for two-way communications between the first MI unit 32 and the second MI unit 34.

In this embodiment, the transmit antenna 114 is also used to receive magneto-inductive signals and the receive antenna 134 also functions to transmit magneto-inductive signals. The transmitter module 146 generates a drive signal for powering the antenna 134 and performs modulation of a data signal supplied by the controller 138 with the drive signal. The drive signal, or carrier signal, in one example is a square wave at or below the resonant frequency of the receive antenna 134 which is below 10 kHz. Other AC drive signals may be used in other embodiments, including sinusoids, etc.

The transmitter module 146 modulates the drive or carrier signal with the data signal to generate a modulated data signal. The modulated data signal is used to drive the receive antenna 134. The receive antenna 134 generates a quasi-static magnetic field 150 based on the modulated data signal.

In this embodiment, the establishment of the magneto-inductive link may be initiated by the second MI unit 34, whereas in the embodiment of FIG. 2 the first MI unit 32 must initiate magneto-inductive communications. Accordingly, the use of the magneto-inductive field 150 to bridge the break 30 may be triggered by break detection by either of the break detection modules 126, 142.

Where the first MI unit 32 and the second MI unit 34 each contain both a transmitter and a receiver (or a transceiver), the break detection modules 126 and 142 may communicate with each other via the magnetic field 150. For example, one break detection module 126 or 142 may transmit a line status response signal via the transmitter module 116 or 146 and the antenna 114 or 134 to the other break detection module 142 or 126 to indicate the safe receipt of a check break data signal from the other break detection module 142 or 126.

The first MI unit 32 and the second MI unit 34 may be powered by a battery 130 and 148. In certain applications, battery power may be preferable to a hardwiring power since, much like the communication line 12, the wires connecting the MI units 32 and 34 to the power source may be severed. The batteries 130 and 148 may be rechargeable and may include a trickle charge circuit for recharging. The low level trickle charge current may be supplied by communication line 12.

The MI system 110 described above may patch a communication line 12 by: detecting a break in the communication line 12 between the first MI unit 32 and the second MI unit 34; transmitting a modulated data signal from the first MI unit 32 via a magneto-inductive transmit module 116 and a transmit antenna 114; receiving a magnetic field 150 that includes a data signal at a receive antenna 134 in a second MI unit 34; modulating the received data for transmission over the communication line 12; and outputting the data onto the communication line 12.

Certain adaptations and modifications of the invention will be obvious to those skilled in the art when considered in light of this description. Therefore, the above discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A magneto-inductive patch unit for connection to a communication line which carries a communication signal, said communication line being connected to at least one other magneto-inductive patch unit, the magneto-inductive patch unit comprising:
a controller;
an antenna having at least one loop for creating a magnetic field;
an interface circuit connected to said communication line, the interface circuit comprising a modem for demodulating the communication signal received from the communication line to obtain a data signal, and a break detection module configured to determine whether the communication line between the magneto-inductive patch unit and the other magneto-inductive patch unit is broken; and
a transmit module connected to the antenna for modulating the data signal at a carrier frequency to generate and output a modulated data signal to drive the antenna, the carrier frequency being below 10 kHz.

2. The magneto-inductive patch unit claimed in claim 1, wherein the communication line comprises a leaky feeder line and wherein the communication signal comprises an RF signal.

3. The magneto-inductive patch unit claimed in claim 1, wherein said controller is configured to enable transmissions by said transmit module in response to detection of a break in the communication line by said break detection module.

4. The magneto-inductive patch unit claimed in claim 1, wherein the break detection module is configured to send a check break data signal from the first magneto-inductive unit to the other magneto-inductive unit via the communication line and await a response from the other magneto-inductive unit to indicate whether the check break data signal was received by the other magneto-inductive unit, and wherein said break detection module includes a timer component configured to determine whether said response is received within a predetermined time.

5. The magneto-inductive patch unit claimed in claim 1, wherein the break detection module is configured to detect receipt of a keepalive signal from the other magneto-inductive unit via the communication line and wherein said break detection module includes a timer component configured to determine whether said keepalive signal is received within a predetermined time.

6. The magneto-inductive patch unit claimed in claim 1, further comprising a receive module connected to said antenna for receiving and demodulating magneto-inductive signals from the other magneto-inductive unit to obtain a received signal, and wherein said modem is configured to modulate said received signal for transmission on the communication line.

7. A magneto-inductive patch system for patching a broken communication line which carries a communication signal comprising:
a first magneto-inductive unit connected to the communication line, said first magneto-inductive unit comprising
a first controller,
a transmit antenna having at least one loop for creating a magnetic field,
a first interface circuit connected to said communication line, the interface circuit comprising a first modem for demodulating the communication signal received from the communication line to obtain a data signal, and a first break detection module, and
a transmit module connected to the first antenna for modulating the data signal at a carrier frequency to generate and output a modulated data signal to drive the first antenna, the carrier frequency being below 10 kHz;
and
a second magneto-inductive unit coupled to said communication line, comprising
a second controller,
a receive antenna having at least one loop for coupling to the magnetic field to receive said modulated data signal,
a receive module connected to the receive antenna for demodulating said modulated data signal to recover said data signal, and
a second interface circuit connected to said communication line, the interface circuit comprising a second modem for modulating said data signal to generate a reproduced communication signal and for transmitting said reproduced communication signal over said communication line, and a second break detection module,
wherein said first break detection module is configured to determine whether here is a break in the communication line between the first magneto-inductive unit and the second magneto-inductive unit.

8. The magneto-inductive patch system claimed in claim 7, wherein the communication line is a leaky feeder line and wherein the communication signal comprises an RF signal.

9. The magneto-inductive patch system claimed in claim 7, wherein said first controller is configured to enable transmissions by said transmit module in response to detection of the break in the communication line by said first break detection module.

10. The magneto-inductive patch system claimed in claim 7, wherein the first break detection module is configured to periodically transmit a check break data signal via the communication line to the second break detection module, wherein the second break detection module is configured to transmit a response signal to the first break detection module upon receipt of the check break data signal, and wherein said first break detection module includes a timer component for determining whether said response signal has been received within a predetermined time and, if not, for outputting a break detected signal to said first controller.

11. The magneto-inductive patch system claimed in claim 7, wherein the second break detection module is configured to periodically transmit a keepalive signal to the first break detection module, and wherein said first break detection module includes a timer component for determining whether said keepalive signal has been received within a predetermined time and, if not, for outputting a break detected signal to said first controller.

12. The magneto-inductive patch system claimed in claim 7, wherein said second modem is further configured to demodulate incoming signals from said communication line, said second magneto-inductive unit further comprises a second transmit module for modulating said incoming signals and transmitting modulated incoming signals as magneto-inductive signals, said first magneto-inductive unit further comprises a first receive module connected to said transmit antenna for receiving and demodulating said magneto-inductive signals from said second magneto-inductive unit to produce a resulting signal, and wherein said first modem is further configured to modulate said resulting signal to generate a reproduced incoming signal for transmission on said communication line.

13. A method of patching a break in a communication line, which carries a communication signal, using a magneto-inductive system that includes a first magneto-inductive unit connected to the communication line and a second magneto-inductive unit connected to the communication line, the first magneto-inductive unit having a transmit antenna having at least one loop for creating a magnetic field, the second magneto-inductive unit having a receive antenna for coupling to the magnetic field, the method comprising the steps of:
detecting a break in the communication line between the first magneto-inductive unit and the second magneto-inductive unit;
demodulating the communication signal to obtain a data signal within the first magneto-inductive unit;
modulating the data signal at a carrier frequency to generate a modulated data signal to drive the transmit antenna, and wherein said carrier frequency is below 10 kHz;
receiving an induced signal in the receive antenna;
demodulating the induced signal to recover the data signal;
modulating the recovered data signal to produce a reproduced communication signal; and
transmitting said reproduced communication signal on said communication line.

14. The method claimed in claim 13, wherein the communication line is a leaky feeder and wherein the communication signal comprises an RF signal.

15. The method claimed in claim 13, wherein the first magneto-inductive unit comprises a magneto-inductive transmitter, and the second magneto-inductive unit comprises a magneto-inductive receiver.

16. The method of claim 13, wherein the step of detecting a break in the communication line between the first magneto-inductive unit and the second magneto-inductive unit includes sending a check break data signal from the first magneto-inductive unit to the second magneto-inductive unit via the communication line, and determining that the second magneto-inductive unit has failed to transmit a response signal to the first magneto-inductive unit within a predetermined time in reply to the check break data signal.

17. The method of claim 13, wherein the step of detecting a break in the communication line between the first magneto-inductive unit and the second magneto-inductive unit includes determining that the second magneto-inductive unit has failed to send a keepalive signal to the first magneto-inductive unit via the communication line within a predetermined time period.
